(19) United States
(12) Patent Application Publication
(10) Pub. No.: US 2006/0108234 A1
(43) Pub. Date: May 25, 2006

(54) Electrochemical process and apparatus

(76) Inventor: Xiao Dong Chen, Auckland (NZ)

Correspondence Address: KILPATRICK STOCKTON LLP, 1001 WEST FOURTH STREET, WINSTON-SALEM, NC, 27101, US

(21) Appl. No.: 10/541,472

(22) PCT Filed: Dec. 22, 2003
(86) PCT No.: PCT/NZ03/00289

§ 371 Date: Sep. 26, 2005

(30) Foreign Application Priority Data
Jan. 6, 2003 (NZ) 523468

(51) Int. Cl. C25F 1/00; B23H 3/02

(52) U.S. Cl. 205/705; 204/228.1

(57) ABSTRACT

A method of applying an electrochemical influence to a component of a machine, in situ, comprises connecting the component, while in situ, into an electrolysis system so that the component functions as at least one electrode of the system. An electrolyte is applied to the component and current is caused to flow through the electrolyte to effect electrochemical cleaning of the component in situ.

### FIELD OF THE INVENTION

This invention relates to the electro-chemical process of electrolysis and in particular to a process and apparatus for applying electrolysis for the in-situ polishing, cleaning and/or sterilisation of metallic surfaces.

### BACKGROUND TO THE INVENTION

Electrolysis is the chemical decomposition of substances, or electrolytes, by an electric current passed through the substance in a dissolved or molten state. The substances are ionized into electrically charged ions, and when an electric current is passed through them by means of conducting electrodes, the ions move towards the oppositely charged electrodes thereby giving up their electric charges to become uncharged atoms or groups, and are either liberated or deposited at the electrode or react chemically therewith.

Electrolysis has wide ranging industrial applications and is primarily used as a method of deposition at the cathode or sacrificial degradation at the anode. Electrolysis also finds application in cleaning and polishing techniques but, to date, has not been fully explored to its potential. The food industry and, in particular, the dairy industry suffers from particular problems associated with cleaning production machinery including heat exchangers. To date, machinery involved in the handling of milk and other dairy products must be shut down entirely for an extended period of time during cleaning operations. The cleaning involves flushing large amounts of caustic cleaning agents through the machines in order to remove residues build up and contamination. Acid cleaning may also be required some times. Once the cleaning is finished the machine must then be rinsed very thoroughly to remove all traces of these cleaning elements and reassembled and recommissioned. These cleaning problems are particularly associated with the cleaning and maintenance of heat exchangers, but extend to other components and also to other industries.

### SUMMARY OF THE INVENTION

According to a first aspect of the invention, there is provided a method of applying an electrochemical influence to a component of a machine, in situ, the method comprising:

connecting the component, while in situ, into an electrolysis system so that the component functions as at least one electrode of the system;

applying an electrolyte to the component; and

causing current flow through the electrolyte to effect electrochemical cleaning of the component in situ.

In this specification, the term “cleaning” is to be understood in a broad sense to include, unless the context clearly indicates to the contrary, polishing, sterilizing, or the like.

The method include causing the component to act as one of a cathode of the system, an anode of the system and as both a cathode and an anode of the system. Hence, the method may include using a switching device in the system to cause the component to switch between functioning as the cathode and as the anode of the system.

The method may include selecting the electrolyte from the group comprising phosphoric acid and sodium hydroxide.

Further, the method may include limiting the current flow through the electrolyte by varying a voltage applied to the system.

The method may include circulating the electrolyte through the system.

According to a second aspect of the invention, there is provided a method of cleaning a bank of spaced metal objects which comprises

while the objects are in situ, making one of the objects function as a cathode of an electrolysis system and making another of the objects function as an anode of the electrolysis system;

applying an electrolyte to the objects; and

applying a voltage between the object acting as the cathode and the object acting as the anode.

The method may include periodically switching the objects to cause the object that had been functioning as the cathode to function as the anode and vice versa. Hence, the method may include using a switching device in the system to switch the objects between functioning as the cathode and as the anode of the system.

The method may include selecting the electrolyte from the group comprising phosphoric acid and sodium hydroxide.

Further, the method include limiting the current flow through the electrolyte by varying a voltage applied to the system.

In addition, the method may include circulating the electrolyte through the system.

The objects may be plates of a heat exchanger and the method may include causing a plurality of the plates to function as the cathode and a further, different plurality of the plates to function as the anode. The method may therefore include selecting each alternate plate as a cathode with the remaining alternate plates functioning as the anode of the system.

According to a third aspect of the invention, there is provided electrochemical cleaning apparatus which comprises

a power source;

a connecting arrangement connected to the power source, the connecting arrangement providing for the connection of a component of machinery to be cleaned, while the component is in situ, to the power source to enable the component to function as at least one electrode of an electrolysis system; and

a reservoir for an electrolyte, the reservoir being coupled, in use, to a part of the machinery to apply the electrolyte to the component.

The component may be configured to act as one of a cathode of the system, an anode of the system and as both a cathode and an anode of the system.

The apparatus may include a switching device to cause the component to switch between functioning as the cathode and as the anode of the system.

The electrolyte may be selected from the group comprising phosphoric acid and sodium hydroxide.

The power source may comprise a variable voltage source for controlling current flow through the electrolyte.

The apparatus may include a circulating means, more particularly a pump, for circulating the electrolyte through the system.

The invention extends also to an electrochemical cleaning assembly for cleaning a bank of spaced metal objects, the assembly comprising

electrochemical cleaning apparatus as described above; and

a plurality of the objects connected to the connecting arrangement of the apparatus while the objects are in situ, so that at least one of the objects functions as a cathode of an electrolysis system so formed and at least one other of the objects functions as an anode of the electrolysis system.

The switching device may periodically switch the objects to cause the object that had been functioning as the cathode to function as the anode and vice versa.

The objects may be plates of a heat exchanger and a plurality of the plates may function as the cathode and a further, different plurality of the plates may function as the anode. Each alternate plate may function as a cathode with the remaining alternate plates functioning as the anode of the system.

### BRIEF DESCRIPTION OF THE DRAWINGS

The invention is now described by way of example with reference to the accompanying drawings in which

FIG. 1 shows a schematic block diagram of electrochemical apparatus, in accordance with an embodiment of the invention, as used in Example 1 below;

FIG. 2 shows an electrolytic cell for simulating treatment of a metal component to be treated as described in Example 1 below;

FIG. 3 shows a schematic block diagram of electrochemical apparatus, in accordance with another embodiment of the invention, as used in Example 4 below;

FIG. 4 shows a test component for Example 4 below as used in the apparatus of FIG. 3;

FIG. 5 shows a cleaning profile for Example 4;

FIG. 6 shows a further cleaning profile for Example 4; and

FIG. 7 shows yet a further cleaning profile for Example 4.

### DETAILED DESCRIPTION OF THE PREFERRED EMBODIMENTS

### EXAMPLE 1

### In-situ Polishing of Heat Exchangers

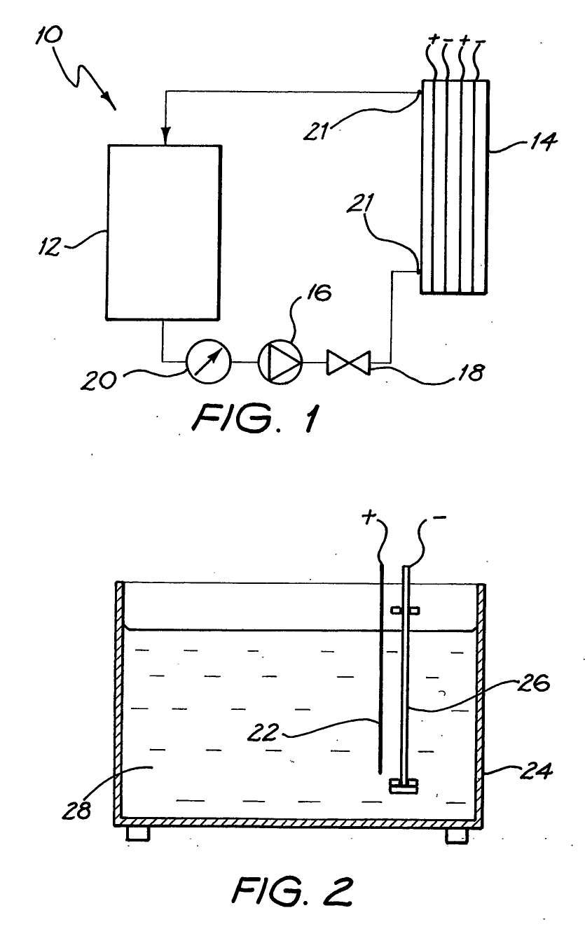

In FIG. 1 of the drawings, reference numeral 10 generally designates an electrochemical apparatus, in accordance with a first embodiment of the invention, for treating metal components. The apparatus 10 includes a reservoir, in the form of an electrolyte tank 12, which supplies an electrolyte to be applied to a metal component 14, illustrated as plates of a heat exchanger. The electrolyte is pumped to the component 14 by a pump 16 through a control valve 18. Electrical current in an electrolysis system or circuit so formed is maintained constant by a power source in the form of a variable voltage controller 20. The component 14 is connected to the voltage controller 20 via a connecting arrangement or connectors 21.

A phosphoric acid electrolytic solution is applied to the metal component or part 14 to be electropolished and a direct current is caused to flow through the electrolytic solution. The variable voltage controller 20 maintains the magnitude of the applied current constant as resistance varies during the electrochemical treatment. The metal part 14 is made the anode in the electrochemical system in which case a separate electrode (not shown) is provided as the cathode. For some types of plate heat exchangers, in which each heating plate is not electrically in contact with an adjacent plate, electropolishing is applied in-situ by using adjacent pairs of heating plates of the heat exchanger as anode and cathode respectively. In order to achieve maximum efficiency, the electrolyte is pumped through the plates of the heat exchanger continuously by the pump 16.

In an experimental condition, 5% (w/w) phosphoric acid was used as the electrolyte under a 5-10 V/cm electric field strength for 15-30 minutes treating time. In high concentrations of phosphoric acid electrolyte (>55%), the removal rate of stainless steel is about 127 microns in 1.64 amp-minutes per square centimetre. The electropolished plate surface showed a different lustre (or light tone) when compared to the unpolished surface.

In order to obtain some microscopic details of electropolishing effects to the stainless steel surface, a group of auxiliary experiments were conducted on small stainless steel plates by using the electrolytic cell as shown in FIG. 2.

Polishing tests for a microscopic investigation were carried out under the same voltage-current conditions using smaller pieces in the specially constructed cell as follows:

Samples comprising stainless steel plates 22 having dimensions of: 2.5 cm×9 cm×0.12 cm were prepared. As part of a pre-treatment procedure, the plates 22 were scored with sandpaper to make directional lines on the surfaces of each plate 22.

A plate 22 was placed in a tank 24 of the electrochemical system to act as an anode of the system. A cathode 26 was also placed in the tank 24 and the plate 22 and the cathode were immersed in an electrolyte 28. The electrolyte comprised, in solution, either: 1) 5% (w/w) phosphoric acid, 5% (w/w) sulphuric acid and water or 2) 30% (w/w) phosphoric acid, 40% (w/w) sucrose and water.

The in-situ, steel plates 22 demonstrated a polished effect. All the advantages of conventional electrochemical polishing for surface pre-treatment are expected to be preserved during in-situ polishing processes. Some typical advantages are:
Removes oxides
Passivates the stainless steel surfaces
Hygienically cleans the treated surfaces
Decarbonises the metal surfaces
No hydrogen embrittlement after sufficient treatment
No directional lines after sufficient treatment
Smooths surface and reduces friction
   Such in-situ processing can be optimized to achieve equipment specific purposes.

### EXAMPLE 2

### Enhanced Cleaning of Fouled Metal Surfaces

When an electric field is applied to a fouled metal surface, besides electropolishing, it can also remove the fouling. Gas bubbles are formed as a result of electrolysing of the solution on the surface of the electrodes as follows:

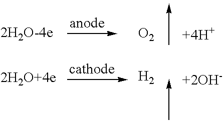

The electrochemical reactions give the following results:
The vicinity of the anode surface became more acidic because of the formation of protons (H⁻). This causes removal of mineral deposits.
The vicinity of the cathode surface becomes more alkaline because of the formation of hydroxyls (OH⁻). This causes swelling of protein deposits facilitating their removal.
The gas bubbles formed provide an additional physical force to dislodge the attached foulant, whether mineral or protein.
   Fouling Removal in Phosphoric Acid

The electrolyte used was a solution containing 5% (w/w) of phosphoric acid. The foulants were prepared by boiling milk. Stainless steel specimens were placed on a heated bottom of a beaker for at least two hours to allow the development of milk fouling formed by thermal denatured protein.

The fouled stainless steel specimen was mounted in an electrolytic cell as one of the electrodes. The gap between the anode and the cathode of the cell was set at about 6 mm. The initial voltage applied was 5 V (DC) allowing an 8.3 V/cm electric-field strength and 0.2 A/cm² current density for electrolysing. When the electric field was applied, large amounts of gas bubbles formed on the electrode surface which provided a physical force to assist in dislodging the attached foulant. As a comparison, one of the sample specimens was soaked in the same phosphoric acid solution for 24 hours. It was found that manual brushing had to be used to obtain the same cleaning result.

Electrolysing also appears to be effective in removing extensive fouling such as burnt-hardened crust on metal surfaces. The samples were prepared by heating the stainless steel specimens to about 300-350° C., and then putting several drops of milk onto them resulting in the milk deposits drying out and becoming burned eventually to form a hardened skin.

Fouling Removal in NaOH Solution

It has also been found that it was even more effective to remove milk fouling using an NaOH dilute solution (0.5 wt %; which is the recommended optimal concentration for milk foulant removal) as an electrolyte and electrolysing at a similar strength as above. In tests without electrolysis, the foulant swelled after being in contact with the NaOH solution. Because of the lack of fluid shear, the deposit would stay swollen but would not detach from the metal surface after more than half an hour. When the specimen was subjected to electrolysis after the similar foulant was put in contact with the solution, swelling of the foulant started almost immediately and some 10 to 15 min thereafter, the foulant was removed and a clean metal surface emerged.

### EXAMPLE 3

### Sterilisation of Microbial Contaminated Metal Surfaces

When an electric field is applied to a fouled metal surface, sterilisation is evidenced.

The experimental conditions were:

4 stainless steel slices (2 cm×10 cm);

15 wt % whole milk as the “culture” liquid for putting live bacteria onto the metal surfaces;

agar gel as the growth medium for live cell counts;

0.5% phosphate acid (pH 1.8);

Current density: 0.2 A/cm²;

Field strength: 8V/cm.

The procedures for the microbial tests were:
(1) Weigh out 120 g whole milk powder into 800 ml water in a beaker, heat and stir until milk powder is completely dissolved;
(2) Immerse the steel slices into the milk and culture at 37° C. overnight;
(3) Prepare 20 sterilised plates with agar and 20 sterilised bottles with water, 4 of them of 10 ml capacity, the other 16 of 9 ml capacity;
(4) Electrolyse the steel slices in the 0.5% phosphate acid separately for 10 minutes and 20 minutes;
(5) Scrape the surface of the slices with cotton;
(6) Wash the cotton in the bottle of 10 ml water;
(7) Dilute the suspensions to 10, 100, 1000 and 10,000 times;
(8) Transfer 1.0 ml of each diluted suspension to each plate with agar;
(9) Culture the plates at 37° C. for 2 days.

The results of the tests are given in the table below. The results suggest that, after electrolysing under the above current strength, the live bacteria were deactivated effectively by the electrolysis actions.

| | Process | | | | |
|---|---|---|---|---|---|
| | *10 | *100 | *1000 | *10.000 | *100,000 |
| Electrolysing | No | No | No | No | No |
| for 20 min | | | | | |
| Electrolysing | No | No | No | No | No |
| for 10 min | | | | | |
| Immersed in | Not sure | No | No | No | No |
| electrolyte | | | | | |
| for 20 min | | | | | |
| Immersed in | Too many to | Too many to | About | 8 | No |
| electrolyte | be counted | be counted | 100 | | |
| for 10 min | | | | | |

### EXAMPLE 4

### Removal of Protein-Gel Deposits from Inner Surface of a Metal Tube

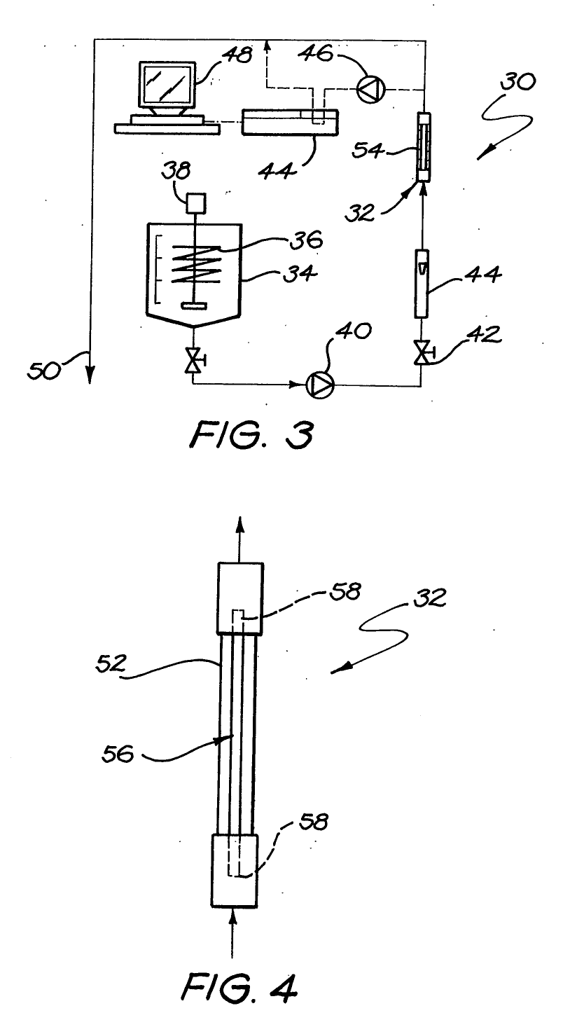

An experimental apparatus for the removal of protein-gel deposits from an inner surface of a metal tube is illustrated schematically in FIG. 3 of the drawings and is designated by the reference numeral 30. The apparatus 30 consists of a stainless steel tube 32 (ID=16 mm and length=150 mm) which forms the test piece and which, as will be described below, has been pre-coated with a whey protein concentrate (WPC) gel film using a rotation rig.

A NaOH solution reservoir 34 contains heating coils and an agitator 38. The reservoir 34 contains the NaOH electrolyte solution of a given concentration and is maintained at the required temperature by the heating coils 36. The electrolyte solution is circulated through the apparatus by a pump 40. Flow velocity of the electrolyte solution in the apparatus 30 is controlled by a valve 42 and is monitored by a float type flow meter 44.

Downstream of the tube 32, the electrolyte solution, containing the removed deposits, is continuously transported to a UV spectrophotometer 44 by a sampling pump 46. The spectrophotometer 44 is connected to a computer 48. Once the material has been sampled it is discharged through a drain 50.

The apparatus records ultraviolet (UV) light absorption at 248 and 256 nm at 10 second intervals to monitor the cleaning process.

To prepare the tube 32, a commercial WPC powder (80.4 wt. % protein, 7.4 wt. % carbohydrate, 5.6 wt. % fat, 3.8 wt. % moisture, 2.8 wt. % ash, pH 6.5) was purchased from a local, New Zealand, dairy company. Aqueous dispersions of 25 wt. % WPC were prepared in a test beaker by agitating until a uniform suspension was obtained. The WPC solution was then accurately weighed and poured into a stainless steel sleeve 52 (FIG. 4). Both sides of the sleeve 52 were tightly sealed by plugs (not shown). The sleeve 52 was placed on a rotating device and immersed in a water bath at a temperature of about 79.5° C. The sleeve 52 was rotated while in a horizontal orientation for about 30 minutes at a rotational speed of about 60 rpm. The sleeve 52, coated with a WPC gel film 54 (FIG. 3), was then cooled by running tap water over the outer surface of the sleeve 52. The coated sleeve 52 was inspected in order to ensure that it had a continuous uniform WPC gel film 54 before being put into the cleaning apparatus 30. The density of the WPC gel film 54 was about 1.10±0.02 g/cm³, which is similar to that of skim milk deposits (1.1-1.2 g/cm³).

The plugs were removed from the sleeve 52 and a metal rod 56 was inserted into the sleeve 52 to act as an anode or cathode with the sleeve 52 forming the other electrode of the electrolysis system of the apparatus 30. PVC tubing 58 was applied to each end of the sleeve 52 to form the tube 32 to be mounted in the apparatus 30.

The most frequently employed spectral range for protein analysis is between about 250 and 320 nm (the near ultraviolet region), UV absorbence measurements in this region providing the most accurate result for determining protein concentrations. The sensitivity of this method is high enough to determine a very dilute protein solution (1 mg/l) encountered in the cleaning study. In this study it has been found that using 0.5 wt. % NaOH solutions instead of pH 13 buffer solutions did not adversely affect the UV absorbence. A linear relationship between the UV absorbence difference at 248 and 256 nm and the WPC concentration in the electrolyte solution was established. Therefore, a continuous and non-invasive UV spectrophotometric method can be used to monitor the cleaning process on-line. The following expression is used for the estimation of protein concentration in the electrolyte solution:
WPC concentration (g/l)=1.0368(A₂₄₈-A₂₅₆)+0.0005
where A₂₄₈ and A₂₅₆ are the values of UV absorbence at the wavelengths of 248 and 256 nm, respectively.

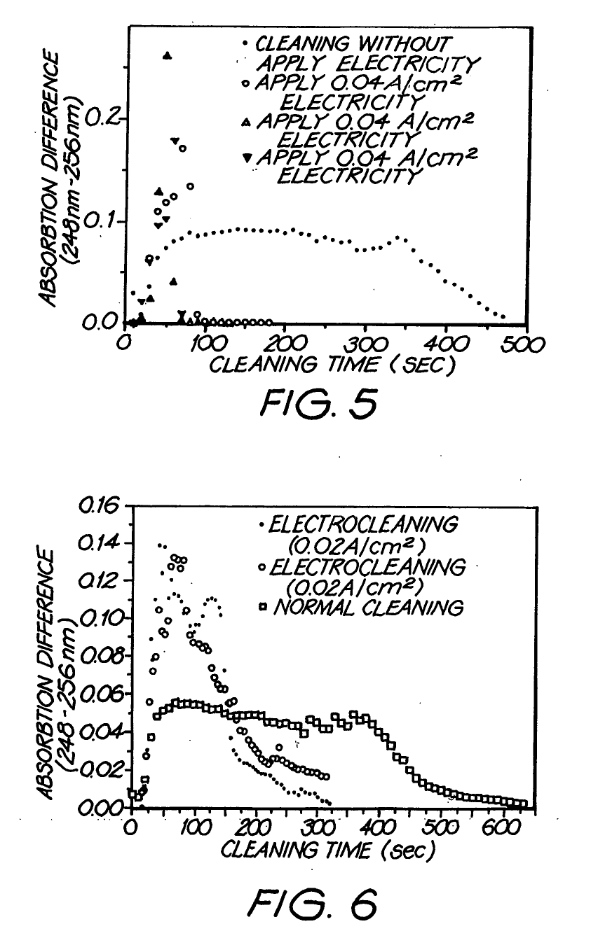

FIGS. 5-7 show the results of cleaning the tube 32 with the technique of the present invention bench-marked against conventional (or normal) cleaning without the applied electrochemical influence. In each of FIGS. 5-7, the Y-axis (absorption difference) is the measure of the concentration of the removed materials in the exit-flow from the test section 32.

Cathodic Cleaning

FIG. 5 shows the effect of cathodic cleaning. The cleaning temperature was about 65° C., the flow velocity was about 0.24 m/s and the cleaning, electrolytic solution was about 0.5 wt % NaOH solution. The WPC gel film was about 0.6 mm thick.

It is to be noted that, in comparison to normal cleaning without in-situ electrolysis, the WPC gel was removed from the tube 32 at a much higher rate.

FIG. 6 also shows the application of cathodic cleaning in comparison to normal cleaning but at a lower current density. The remaining experimental parameters were the same as for the experiment shown in FIG. 5. Once again, using the technique of the present invention even at the lower current density, resulted in a more efficient cleaning operation being effected.

Periodic Polarity Reversal Electrocleaning

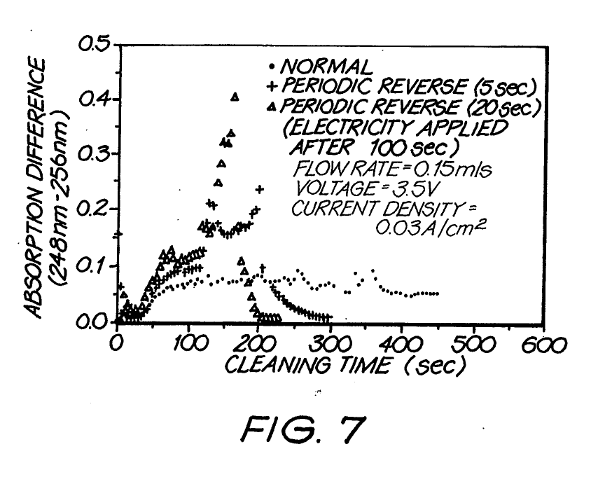

FIG. 7 of the drawings shows the result where the anodic and cathodic modes were switched about every 10 seconds with an applied voltage of about 3V and a current density of 0.02 A/cm². The flow rate of the NaOH solution was about 0.3 m/s, its temperature was about 65° C. and its concentration was about 0.5 wt %. Once again the WPC gel film was about 0.6 mm thick.

It is to be noted therefore that, in all the cases illustrated in FIGS. 5-7, the electrochemical method of the invention gives superior results compared with the conventional method.

The process and apparatus of the invention provides for in-situ polishing, cleaning and/or sterilisation of metal components which can be treated in place without dismantling of machinery of which the components form part.

The invention provides a method which can be widely applied to a range of industrial process systems enabling efficient maintenance to be accomplished without long down time for repairs.

Thus, an advantage of the invention is to harness the principles of electrolysis to assist in the polishing, cleaning and/or sterilisation of metal components of machinery. The invention uses the principles of electrolytic decomposition for the maintenance and upkeep of a wide range of industrial machinery where the electrolyte is applied in situ to the machine in question as a liquid flowing through the machinery components, without the machine requiring any degree of dismantling. The application of electrolyte to the intact machinery, utilizes a much lower level of electrolyte in suspension which allows maintenance and cleaning operations to be conducted in situ. This results in a very low down time and the use of caustic and other cleaning agents at far lower concentrations.

Accordingly, the invention provides for the first time, methods utilizing principles of electrolysis for cleaning, polishing, sterilizing and maintenance of complex industrial machinery without the need for dismantling or disassembling such machinery into its component parts for cleaning and maintenance. The combined use of mild caustic solutions to remove protein or mild acidic solutions to remove mineral deposits as appropriate, in conjunction with careful control of voltage to maintain the current constant, as appropriate, results in a highly efficient method, allowing regular and speedy maintenance with minimal down time. The invention has particular application to the dairy industry, where fouled heat exchangers can be readily cleaned with minimal shut down time and minimal interruption to production. In such application involving electrolytic polishing, minimal interference and damage is caused to machinery components as the electrolytic action removes only minuscule amounts of the metal components. The method thereby serves to greatly extend the life of such components. Also, because much lower concentrations of cleaning fluids are used, subsequent rinsing of the machinery to remove the cleaning fluids is facilitated.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of applying an electrochemical influence to a component of a machine, in situ, the method comprising:
connecting the component, while in situ, into an electrolysis system so that the component functions as at least one electrode of the system,
applying an electrolyte to the component; and
causing current flow through the electrolyte to effect electrochemical cleaning of the component in situ.

2. The method of claim 1 which includes causing the component to act as one of a cathode of the system, an anode of the system and as both a cathode and an anode of the system.

3. The method of claim 2 which includes using a switching device in the system to cause the component to switch between functioning as the cathode and as the anode of the system.

4. The method of any one of the preceding claims which includes selecting the electrolyte from the group comprising phosphoric acid and sodium hydroxide.

5. The method of any one of the preceding claims which includes limiting the current flow through the electrolyte by varying a voltage applied to the system.

6. The method of any one of the preceding claims which includes circulating the electrolyte through the system.

7. A method of cleaning a bank of spaced metal objects which comprises
while the objects are in situ, making one of the objects function as a cathode of an electrolysis system and making another of the objects function as an anode of the electrolysis system;
applying an electrolyte to the objects; and
applying a voltage between the object acting as the cathode and the object acting as the anode.

8. The method of claim 7 which includes periodically switching the objects to cause the object that had been functioning as the cathode to function as the anode and vice versa.

9. The method of claim 7 or claim 8 which includes using a switching device in the system to switch the objects between functioning as the cathode and as the anode of the system.

10. The method of any one of claims 7 to 9 which includes selecting the electrolyte from the group comprising phosphoric acid and sodium hydroxide.

11. The method of any one of claims 7 to 10 which includes limiting the current flow through the electrolyte by varying a voltage applied to the system.

12. The method of any one of claims 7 to 11 which includes circulating the electrolyte through the system.

13. The method of any one of claims 7 to 12 in which the objects are plates of a heat exchanger and in which the method includes causing a plurality of the plates to function as the cathode and a further, different plurality of the plates to function as the anode.

14. The method of claim 13 which includes selecting each alternate plate as a cathode with the remaining alternate plates functioning as the anode of the system.

15. Electrochemical cleaning apparatus which comprises
a power source;
a connecting arrangement connected to the power source, the connecting arrangement providing for the connection of a component of machinery to be cleaned, while the component is in situ, to the power source to enable the component to function as at least one electrode of an electrolysis system; and
a reservoir for an electrolyte, the reservoir being coupled, in use, to a part of the machinery to apply the electrolyte to the component.

16. The apparatus of claim 15 in which the component is configured to act as one of a cathode of the system, an anode of the system and as both a cathode and an anode of the system.

17. The apparatus of claim 16 which includes a switching device to cause the component to switch between functioning as the cathode and as the anode of the system.

18. The apparatus of any one of claims 15 to 17 in which the electrolyte is selected from the group comprising phosphoric acid and sodium hydroxide.

19. The apparatus of any one claims 15 to 18 in which the power source comprises a variable voltage source for controlling current flow through the electrolyte.

20. The apparatus of any one of claims 15 to 19 which includes a circulating means for circulating the electrolyte through the system.

21. An electrochemical cleaning assembly for cleaning a bank of spaced metal objects, the assembly comprising
electrochemical cleaning apparatus as claimed in any one of claims 15 to 20; and
a plurality of the objects connected to the connecting arrangement of the apparatus while the objects are in situ, so that at least one of the objects functions as a cathode of an electrolysis system so formed and at least one other of the objects functions as an anode of the electrolysis system.

22. The assembly of claim 21, insofar as it is dependent on claim 17, in which the switching device periodically switches the objects to cause the object that had been functioning as the cathode to function as the anode and vice versa.

23. The assembly of claim 21 or claim 22 in which the objects are plates of a heat exchanger and a plurality of the plates function as the cathode and a further, different plurality of the plates function as the anode.

24. The assembly of claim 23 in which each alternate plate functions as a cathode with the remaining alternate plates functioning as the anode of the system.
